(19) United States
(12) Patent Application Publication
(10) Pub. No.: US 2016/0189025 A1
(43) Pub. Date: Jun. 30, 2016

(54) SYSTEMS AND METHODS FOR CROWD-VERIFICATION OF BIOLOGICAL NETWORKS

(71) Applicants: William HAYES, Cambridge, MA (US); Julia HOENG, Corcelles (CH); Manuel Claude PEITSCH, Peseux (CH); Philip Morris Products S.A., Neuchatel (CH); Selventa, Cambridge, MA (US)

(72) Inventors: William Hayes, Marlborough, MA (US); Julia Hoeng, Corcelles (CH); Manuel Claude Peitsch, Peseux (CH)

(21) Appl. No.: 14/902,944

(22) PCT Filed: Aug. 12, 2014
(86) PCT No.: PCT/EP2014/067276

§ 371 Date: Jan. 5, 2016

Related U.S. Application Data
(60) Provisional application No. 61/864,904, filed on Aug. 12, 2013.

(51) Int. Cl. G06N 3/06; G06N 3/08

(52) U.S. Cl. CPC G06N 3/061; G06N 3/08

(57) ABSTRACT

Systems and methods are provided for curating and disseminating a network model. A representation of a network model is provided, and data is received that is representative of user actions. The user actions are directed to at least one element of the network model. A score is assigned to each respective element based on a number of user actions received for the respective element. A verified subset of edges is identified that have assigned scores that exceed a verification threshold, and a rejected subset of edges is identified that have assigned scores that are below a rejection threshold. The verified subset of edges and the associated nodes are provided as a curated network model, which omits the rejected subset of edges.

### BACKGROUND

For nearly 20 years, crowdsourcing initiatives have been used to draw upon and focus the expertise of a broad, heterogeneous technical community to address specific questions framed as ‘challenges’. These challenges have addressed topics as diverse and labor-intensive as predicting user ratings for films (Netflix challenge), knowledge discovery and data mining (KDD cup, www.kdd.org/kddcup/, [Kohavi R, Brodley C E, Frasca B, Mason L, Zheng Z. KDD-Cup 2000 organizers' report: peeling the onion. ACM SIGKDD Explorations Newsletter. 2000; 2(2):86-93]), microarray and next-generation sequencing (MAQC, www.fda.gov/MicroArrayQC/, [Shi L, Campbell G, Jones W D, et al. The Microarray Quality Control (MAQC)-II study of common practices for the development and validation of microarray-based predictive models (EI). 2010]), and protein-folding (FoldIt, www.fold.it, [Good B M, Su A I. Games with a scientific purpose. Genome Biology. 2011; 12(12):135]). Crowd-based approaches have also been attempted to collect scientific knowledge in common depositories such as BioCarta (www.biocarta.com/) or WikiPathways (www.wikipathways.org, [Pico A R, Kelder T, van Iersel M P, Hanspers K, Conklin B R, Evelo C. WikiPathways: pathway editing for the people. PLoS biology. Jul. 22, 2008; 6(7):e184]). However, these approaches are not robust enough for use in verifying the resulting knowledge that may be derived by combining the data reported in a myriad of publications. Complex, relational data cannot be easily evaluated through the classical peer review process [Meyer P, Alexopoulos L G, Bonk T, et al. Verification of systems biology research in the age of collaborative competition. Nat Biotechnol. September 2011; 29(9):811-815]. The present invention provides a system that may address the need of scientists and engineers who are facing an explosive growth of data and publications in a technical area.

### SUMMARY

As noted above, early solutions for verifying knowledge by appointed individuals may not match the speed required where an abundance of quantitative data concerning various related aspects of a single complex topic is generated by many researchers in a short period of time. Applicants have recognized that curating a network model by a crowd and dissemination of the resulting curated network model may be facilitated by the use of a computer network. The computer systems and computer program products described herein implement methods that include curation of a network model by including input from multiple individuals. By aggregating the opinions of multiple users, the present disclosure allows for the development of a detailed understanding regarding which portions of a network model are valid in the views of multiple individuals, and which portions of a network model require further investigation.

In certain aspects, the systems and methods of the present disclosure provide a computerized method for curating a network model. The computerized method includes providing, by a computer system including a communications port and at least one computer processor in communication with at least one non-transitory computer readable medium storing at least one electronic database comprising data representative of an initial network model and elements of the initial network model. The initial network model includes a plurality of nodes interconnected with a plurality of edges, each edge being representative of a causal relationship between two connected nodes. User actions are requested from a plurality of users, the user actions being directed to an element of the network model. An element of a network model can be an edge, a node or an item of information associated with an edge, a node or a portion of the model. Then, a score is assigned to each element of the network model based on the user actions received for the respective element, and verified elements that each have a score that exceeds a verification threshold are identified. Data representative of a curated network model that comprises the verified elements of the initial network model are provided providing via the communications port.

In certain implementations, the computerized method further comprises identifying rejected elements that each have a score that is less than a rejection threshold, wherein the curated network model omits the rejected elements. Non-verified elements are identified that each have a score greater than the rejection threshold and less than the verification threshold, and indicating the non-verified elements in the curated network model.

In certain implementations, at least some of the user actions are binary votes provided by the users that indicate whether the user approves or disapproves an element of the network model. The score assigned to a respective element is a function of the number of received user actions directed to the respective element, a characteristic of each of the received user actions, or both. The characteristic of each of the received user action may include an indication of whether the respective user action is of a positive nature or of a negative nature.

In certain implementations, at least some of the user actions includes a provision of information associated with a node or an edge. The computerized method may further comprise disseminating data representative of the curated network model to at least the plurality of users or the public. At least one user action may include a suggestion for a new node or a new edge previously absent from the representation of the network model, and the method may further comprise modifying the network model by including the new node or the new edge.

In certain implementations, the network model represents a biological system, each node represents a biological entity that interacts with at least one of the other nodes, and each edge represents a causal relationship between the biological entities in the biological system. In certain implementations, the network model is a biological network model that represents a biological system, the biological network model being a subset of a macro network model and being defined by selecting a boundary of the macro network model. The data that represents the network model is provided using Biological Expression Language.

In certain implementations, the computerized method further comprises using an integrated reputation system to manage incentives awarded to individual users according to the user actions of each respective user. The integrated reputation system assigns a number of points to a user according to the user action, wherein the number may be modified according to the status of the network model. The one or more factors that can be used to determine the status of the network model include the number of user actions received for the element, the nature of the user actions received for the element, or the location of the node or edge relative to the other nodes and edges in the network model. The reputation system awards additional points to a user based on a user action directed to the verification of an element, prior to the element being verified by subsequent user actions. Other factors that reflect the progress made in enhancing or verification of the network model may be used to determine the functioning and programming of the integrated reputation system.

In certain implementations, at least one of the user actions creates a new edge in the network model, the new edge being previously absent from the representation of the network model. A number of points assigned to a user who provided the new edge is larger than a number of points assigned to a user who provided a modification of an existing edge in the network model. In certain implementations, the user actions received from different users may be independent of one another. This can be effected by not displaying or hiding the actions directed to an element taken by a user to other users, or by not displaying to a user the modifications to an initial network model that are made by other users. In certain implementations, the users are ranked according to a number of reputation points accumulated by the users.

### BRIEF DESCRIPTION OF THE DRAWINGS

Further features of the disclosure, its nature and various advantages, will be apparent upon consideration of the following detailed description, taken in conjunction with the accompanying drawings, in which like reference characters refer to like parts throughout, and in which:

FIG. 1 is a block diagram of a computer network for providing a network verification process.

FIG. 2 is a block diagram of a server for providing a network verification process.

FIG. 3 is a block diagram of an exemplary computing device which may be used to implement any of the components in any of the computerized systems described herein.

FIG. 4 is an illustrative BEL statement for representing a relationship between two nodes in a network model.

FIG. 5 is an illustrative graphical diagram of a network model and its elements.

FIG. 6 is a table of numbers of points that are assigned to a user for taking various user actions related to a network model.

FIG. 7 is a flow diagram of an illustrative process for curating a network model.

### DETAILED DESCRIPTION

Described herein are computational systems and methods for curating a model of a network and dissemination of the model. The approaches described herein allow for the curation and verification of a network model by multiple individuals. The present disclosure allows for the development of a detailed understanding regarding which portions of a network model are valid in the views of multiple individuals, and which portions of a network model require further investigation. The development of this understanding is recorded and effectively shared by a community of users, and the records represent state-of-the-art of the knowledge at various time points.

Though network models are a powerful way of representing complex information, network models may easily become unwieldy to navigate and manage as their size, complexity and density increases with additional data. However, there is currently a lack of efficient tools to build, share, and maintain these network models in a collaborative environment. As described herein, the present methods and systems mitigate these difficulties by enabling many individuals to work in parallel to curate and share large complex growing network models. The present disclosure provides systems and methods for supporting a collaborative, crowd-sourced, network model building and verification project that is managed effectively through the use of a social reputation engine. Thus, the systems and methods of the present disclosure comprise a set of network curating functions which are linked to a set of user reputation management functions. The systems and methods disclosed herein may be viewed as a platform for providing any network research community with a high-performance environment for the qualification, verification and optionally dissemination of network models.

In one implementation, the network curation project as described herein has a predefined termination date after which no user actions directed to the network model will be accepted by the system. The network model or a portion thereof may be deemed to have been verified by a set of users based on the exchange and recording of knowledge within the time period. Optionally, the verified network model and associated information and knowledge are disseminated or published. The verification by multiple individuals enabled by the systems and methods described herein can replace the peer review process that is typically conducted prior to publication in an academic journal. In another implementation, the network curation project as described herein is a continuous effort without a predefined time of termination of the project. In such a project, a network model is progressively expanded and consistently refined as new evidence is added and accumulated over a period of time. In this manner, the project is more than the verification of a network model, but a long-term curation and refinement process that may be used to expand and maintain current knowledge in a subject matter area.

The presently disclosed systems and methods provide a technical community with certain benefits, which include an accelerated mechanism for the qualification, verification and dissemination of a network model and associated information, better representation of knowledge in a subject matter area, a forum for sharing reproducible and reusable results, a platform that links those who generate network models with others who may validate hypotheses underlying the network models and translate modeling results into practical uses.

In some implementations of the present disclosure, the approach comprises several phases. In a construction phase, models of networks are constructed based on technical or scientific literature and the hypotheses underlying the constructed models are validated by available data. The network models are then imported into and maintained on an online system by an organizer over which the verification phase is conducted. In the verification phase, the organizer communicates with a group of individuals or the “crowd” (members of a scientific community, subject matter experts, students and researchers, or a combination thereof, for example) about the online network model. Furthermore, the organizer invites the crowd, now users, to review and provide comments, evidence, votes, or a combination thereof regarding various aspects and elements of the model. By aggregating the user input, the network model may be modified, verified, and enhanced. The verification phase may be set up as a competition between individual users or teams of users who provide comments, evidence, or votes resulting in qualified modifications of the network model. As used herein, the term “element” of a network model includes an edge, a node, a piece of information or evidence concerning an edge or a node. An edge or a node can each be associated with multiple items of information and evidence. The information can be any data, images, experimental observations, comments, opinions, likes or dislikes. The information or evidence can be a part of an intiail network model or it can generated or submitted by a user. Each action performed by a user may be recorded and assigned a certain predefined number of reputation points according to the nature of the action. The number of points accumulated by individual users or teams may be collectively displayed to the users or teams periodically or in real time, possibly in the form of a leaderboard. At a certain time after the verification phase has begun, an analysis of the resulting network model and the user actions allows an organizer to identify a number of nodes or edges in the resulting network model that produce (i) a significant number of convergent user actions and comments; or (ii) a significant number of divergent user actions and comments. An analysis of user actions and comments may reveal the portions of the network model or edges that are verified, not verified or not verifiable by the crowd. The results of the analysis may enable decisions to be made by the organizer about the dissemination of the network model or portions thereof.

In various implementations of the present disclosure, the network models represent the functions and mechansims of biological systems. Over the last 10-20 years, the development of revolutionary tools for biological research has enabled the acquisition of large amounts of data in a systems-wide approach. The emergence of technology to reproducibly generate such data has ushered in the era of systems biology. This shift has made possible the expansion of experimental work aimed at evaluating changes in gene expression from low-throughput technologies like single gene polymerase chain reaction, traditionally executed for the verification of a working hypothesis, to system-wide evaluation of the transcriptome in various settings for the purpose of hypothesis generation. Consequently, scientific output is increasing exponentially as the size and number of datasets being deposited into databases grows, along with the quantity of scientific articles published.

The total volume of biological pathway information has grown dramatically, with the number of online resources for pathways and molecular interactions increasing 70% from 190 in 2006 [Bader, G. D. Cary, M. P. and Sander, C. (2006) Pathguide: a pathway resource list. Nucleic Acids Research. 34, D504-D506] to 325 in 2010. This indicates that the scientific community recognizes that such information greatly facilitates the understanding of the effects that biologically active substances have on biological systems. Network biology provides a coherent framework for investigating the impact of exposures at the molecular, pathway, and process levels [Hasan, S. et al. (2012) Network analysis has diverse roles in drug discovery. Drug discovery today]. Drugs for many disease states may require multiple activities to be efficacious; thus, network biology may indeed be used to investigate drugs that perturb biological networks rather than individual targets [Yildinm, M. A. et al. (2007) Drug-target network. Nature Biotechnology. 25, 1119]. Moreover, network biology provides a platform to potentially understand side effects of drug candidates as well as predictions in polypharmacology [Hopkins, A. L. (2008) Network pharmacology: the next paradigm in drug discovery. Nature chemical biology. 4, 682-690]. It is contemplated that methods and systems within the scope of this disclosure may be applied to the practice of systems toxicology or systems pharmacology which will improve the understanding of disease mechanisms and thereby provide more effective and safer treatments for patients.

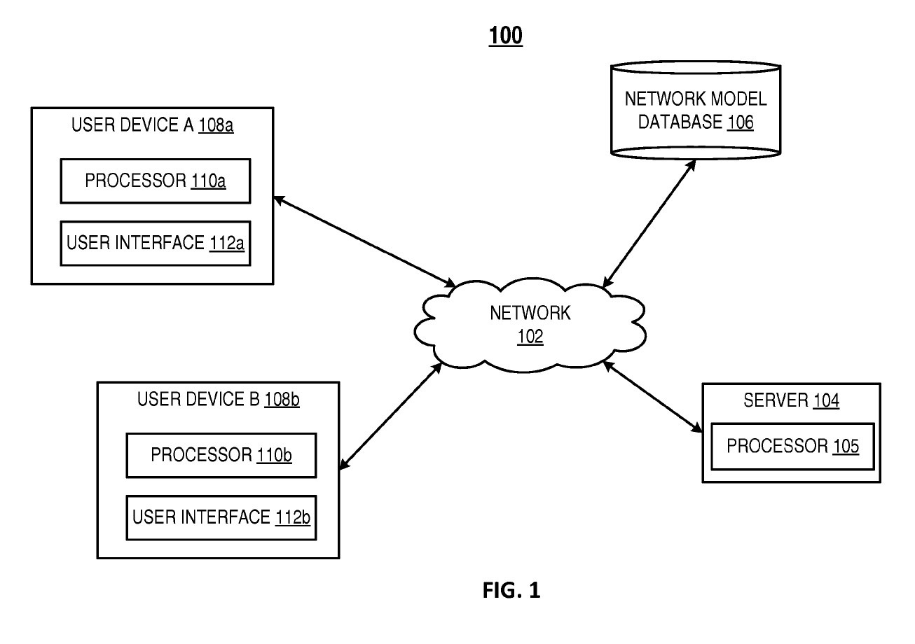

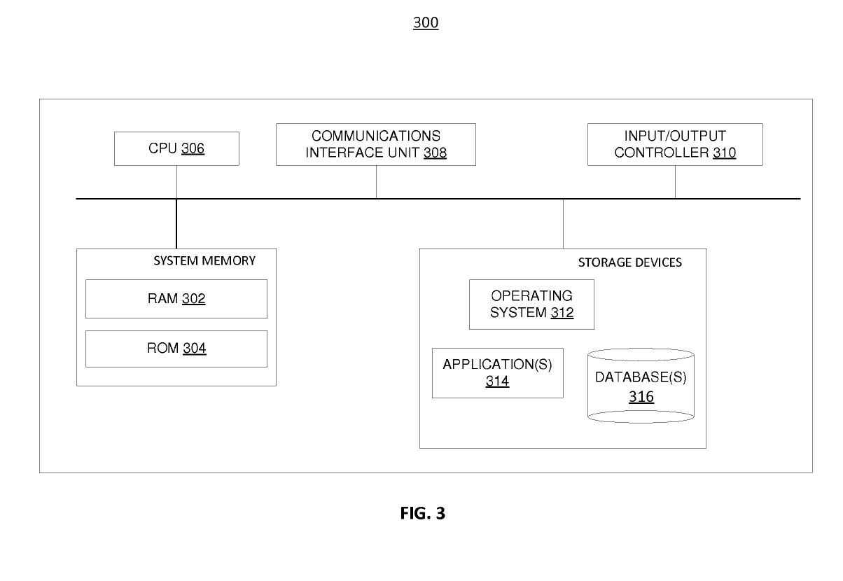

FIG. 1 depicts an example of a computer network and database structure that may be used to implement the systems and methods disclosed herein. FIG. 1 is a block diagram of a computerized system 100 for performing curation of a biological network model, according to an illustrative implementation. The system 100 includes a server 104 and two user devices 108a and 108b (generally, user device 108) connected over a computer network 102 to the server 104. The server 104 includes a processor 105, and each user device 108 includes a processor 110a or 110b and a user interface 112a or 112b. As used herein, the term “processor” or “computing device” refers to one or more computers, microprocessors, logic devices, servers, or other devices configured with hardware, firmware, and software to carry out one or more of the computerized techniques described herein. Processors and processing devices may also include one or more memory devices for storing inputs, outputs, and data that is currently being processed. An illustrative computing device 300, which may be used to implement any of the processors and servers described herein, is described in detail below with reference to FIG. 3. As used herein, “user interface” includes, without limitation, any suitable combination of one or more input devices (e.g., keypads, touch screens, trackballs, voice recognition systems, etc.) and/or one or more output devices (e.g., visual displays, speakers, tactile displays, printing devices, etc.). As used herein, “user device” includes, without limitation, any suitable combination of one or more devices configured with hardware, firmware, and software to carry out one or more computerized actions or techniques described herein. Examples of user devices include, without limitation, personal computers, laptops, and mobile devices (such as smartphones, tablet computers, etc.). Only one server, one database, and two user devices are shown in FIG. 1 to avoid complicating the drawing, but one of ordinary skill in the art will understand that the system 100 may support multiple servers and any number of databases or user devices.

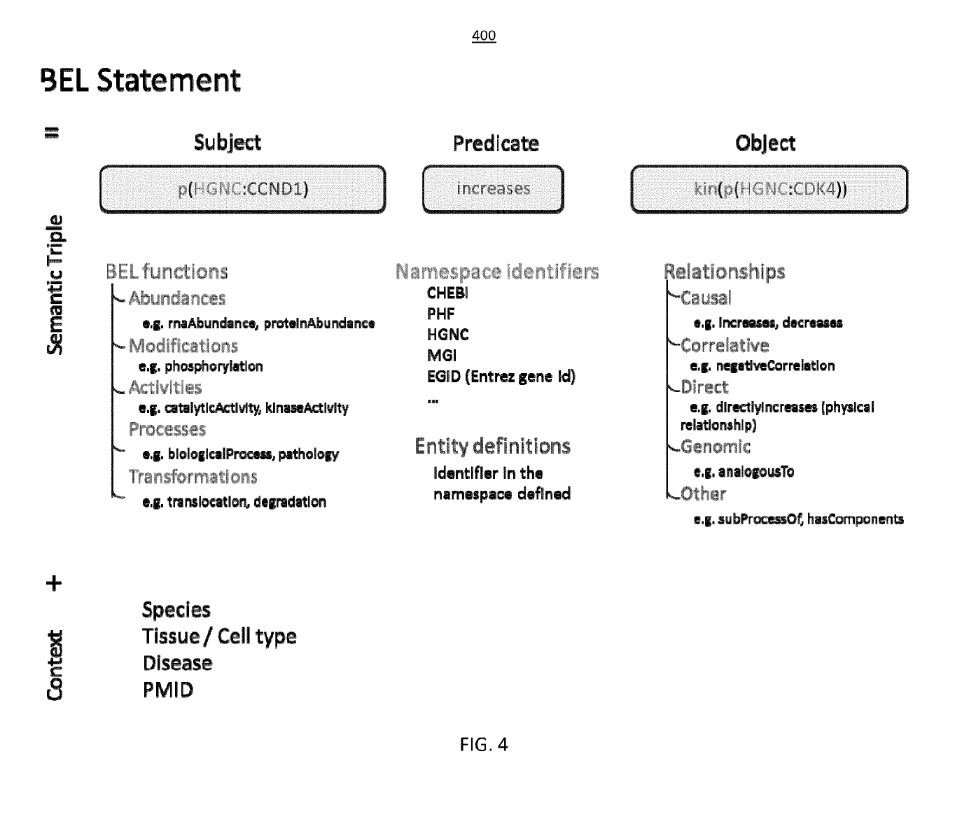

The network model database 106 is a database that includes data representative of a network model and elements of the network model. A representation of the network model is displayed to the users over the user interfaces 112, and users at the user devices 108 interact with the user interfaces 112 to provide user inputs over the network 102. The system thus requests and receives data from a user representative of a user action, and generally manages a user session. For example, when the network model is a model of a biological system, the representation of the network model may be in the form of one or more statements in Biological Expression Language (BEL), as is described in relation to FIG. 4. A user may select a portion of a displayed network model, and one or more BEL statements may be displayed over the user interface 112. The BEL statements may provide an indication of a relationship between two nodes (the subject and the object, for example) of the network, and as provided by the system, the user may select to vote on the BEL statement or the one or more pieces of evidence that concern, support or refute the BEL statement. In an example, the user may vote to indicate that a piece of evidence supports a BEL statement, thereby qualifying the verification of the relationship represented by the BEL statement. In another example, the user may vote to indicate approval of a BEL statement without qualification. In yet another example, the user may vote to indicate that a piece of evidence does not support a BEL statement, thereby refuting the relationship represented by the BEL statement. In yet another example, the user may vote to indicate disapproval of a BEL statement without qualification. The system may offer a user an option to provide a suggested modification to the BEL statement, such as a change to one or both nodes, or a change to a quality or a value associated with the edge (the predicate of the BEL statement, for example) between the two nodes. The system may also offer a user an option to provide qualifying evidence for the suggested modification. The suggested modification and evidence may be recorded in the network model database 106. The modified network model may optionally be displayed in real time. Then, other users who are interacting with the network model over other user interfaces 112 may view the updated network model in real time and provide feedback regarding the suggested modification.

As described herein, elements or portions of the network model (such as a set of BEL statements or pieces of evidence concerning one or more BEL statements) are verified when the number of votes indicating approval exceeds a verification threshold, or equivalently, when a number of users that accept a part of the model exceeds the verification threshold. Other elements or portions of the network model (that received votes indicating approval below a rejection threshold, for example) may be identified as rejected, and one or more of these elements or portions may be indicated to the organizer and/or deleted from the modified network model. Still other portions of the network model (that received votes indicating approval between the verification threshold and the rejection threshold, for example) may be identified as questionable, and one or more of these elements or portions may be indicated to the organizer and/or marked for further scientific investigation or deletion from the modified network model. The verification and rejection thresholds may be defined by the organizer according to the objective of the project. For example, the verification threshold, the rejection threshold, or both thresholds may be defined according to an absolute number of votes or users indicating approval or disapproval (e.g., 5, 6, 7, 8, 9, 10, 11, 12, 13, 14 or 15 votes or any other suitable number of votes); or they can be based on the relative proportion of votes indicating approval or disapproval (e.g., greater than 50%, greater than 60%, greater than 70%, greater than 80%, greater than 90%, or 100%), and optionally votes indicating a lack of opinion, or a combination thereof.

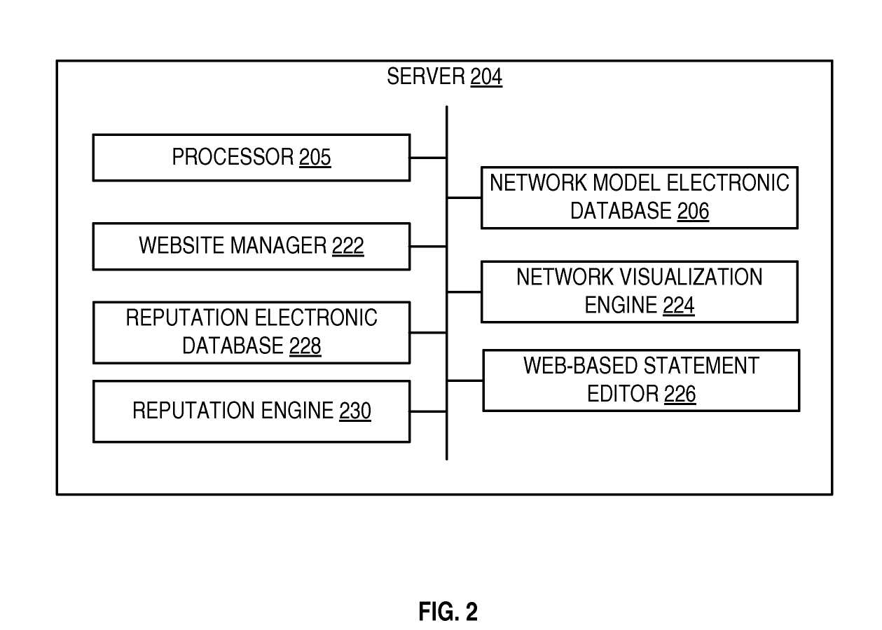

The components of the system 100 of FIG. 1 may be arranged, distributed, and combined in any of a number of ways. For example, a computerized system may be used that distributes the components of system 100 over multiple processing and storage devices connected via the network 102. Such an implementation may be appropriate for distributed computing over multiple communication systems including wireless and wired communication systems that share access to a common network resource. In some implementations, the system 100 is implemented in a cloud computing environment in which one or more of the components are provided by different processing and storage services connected via the Internet or other communications system. The server 104 may be, for example, one or more virtual servers instantiated in a cloud computing environment. In some implementations, the server 104 is combined with the network model database 106 into one component, an example of which is described in detail in relation to FIG. 2.

FIG. 2 is a block diagram of a server 204 that performs any of the functions described herein. The server 204 includes a processor 205, a website manager 222, a network model electronic database 206, a network visualization engine 224, a web-based statement editor 226, a reputation electronic database 228, and a reputation engine 230, all connected over a bus.

The network model electronic database 206 may include a database of a network model including multiple versions of the network model, such as but not limited to an initial network model, modified network models created by user actions, curated network models, and a consensus network model. In some implementations, the network models are expressed in BEL and represent qualitative biology in a scale-free representation. The nodes are BEL terms and are identified using biological databases such as but not limited to SwissProt (see www.uniprot.org), EntrezGene (see www.ncbi.nlm.nih.gov/gene), Rat Genome Database (see rgd.mcw.edu), and ChEBI (see www.ebi.ac.uk/chebi/). The network edges are BEL Statements that connect two nodes, maintain the computability of the network, and are supported by evidence from the scientific literature. Both the network structure and supporting evidence can be stored in a MongoDB database (www.mongodb.org). BEL statements are described in more detail in relation to FIG. 4.

The server 204 further includes a website manager 222 that manages a website to facilitate the visualization and review process as well as the user login process. The website may be provided over the user interfaces 112 to multiple users. As an example, the website displays an overview of a proposed or modified network model representing the connections and relationships between several smaller subnetwork models. The website manager 222 also provides functionality to select one of these subnetwork models for review. The website manager 222 may also provide a list of network models for selection, or the website manager 222 may be configured to allow the user to use a search function that will allow searching across the network identifier, summary, elements, individual nodes, edges, and any synonyms of biological entities (gene or protein), or any other suitable data related to a network model. The website manager 222 also supports a full set of user actions that may be used in the course of curating a network model. For example, a user may be provided with one or more options to add, remove, replace, or modify an element (an edge or a node) of a network model. In addition, a user may be provided with one or more options to add, remove, replace, modify or comment on an evidence supporting an element of the network model.

In one implementation, an action that a user takes with respect to a network model and its elements may optionally require ratification by at least one other user through a voting process. Once ratified, the action may be entered to modify a stored version of an initial network model or to further modify a stored version of a modified network model. The modified network model and other versions may be displayed to the users in real time. After an initial network model is modified by a user's action, the network model becomes a modified network model, which may be subjected to further modification(s) by other action(s) of the same user or different user(s). As the modifications accumulate, multiple versions of the model may be stored, each of which represents a certain number of modifications that have been made to the initial model. The modifications may be stored in a database of modifications, with field entries including data related to the updated elements (node(s), edge(s), new evidence) and the identifier of the user who suggested the modification. As other users provide input regarding the modification, the database may be updated to include the identifier of the users who provide the input, such as votes, comments, additional modifications, or evidence. In certain implementations, the actions of multiple users will result in numerous modifications of the initial network model at the beginning of a project. After a period of time, the number of new modifications may decrease and may eventually approach zero. At this point, the modified network model may be referred to as a verified or consensus network model, which may optionally be disseminated to a community.

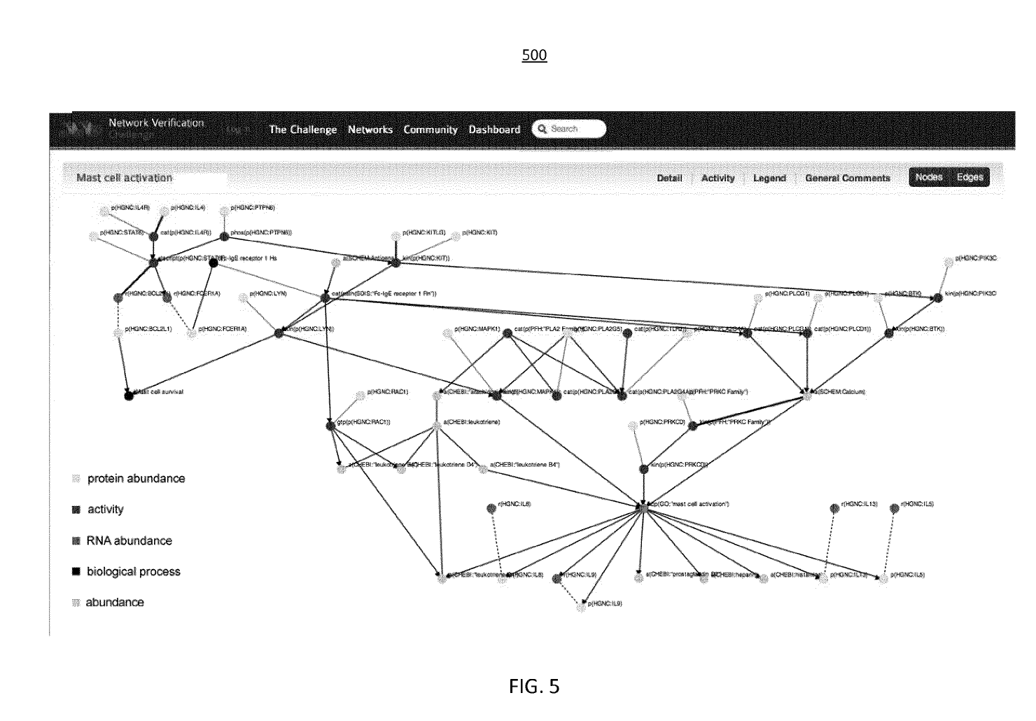

The network visualization engine 224 provides a visualization of a network model on a video display unit or in printed form. For example, the network visualization engine 224 may be powered by D3.js (www.d3js.org). The network visualization engine 224 allows users to view the network model graphically and optionally allow user to graphically add, delete, replace, or modify elements (such as edges) of a model. Users may optionally be provided with a function for adding comments to a network model and providing different visualization filters for the networks. Such filters include the visualization of the initial network, the current network after modification, or the initial network model with the proposed modification presented as layers on top of the initial network. FIG. 5 shows an example of a portion of a network model that may be generated by the network visualization engine 224.

The web-based statement editor 226, optionally provided, may allow a user to propose a change in the network model. In an example, a user may propose to change a network edge that is represented by a BEL statement. In some implementations, all network edges are represented by BEL statements, some of which are supported by at least one technical literature reference. The web-based statement editor 226 may be a web-based BEL statement editor, which supports a user with features that provide guidance on the functional syntax of the BEL Statement. For example, an autocomplete terminology service may provide support in entering protein names, chemical compound names, Gene Ontology terms, and other biological entities used in a BEL Statement. The web-based statement editor 226 may also suggest which statement functions and types of entities are allowed at the cursor position as the BEL Statement is being created. An example BEL statement is described in relation to FIG. 4.

The reputation electronic database 228 stores data related to the users. For example, each user may be assigned a unique user identifier. A user may be prompted for a username and a password to log into the website over the user interface 112. Each user may be associated with a number of reputation points and optionally a plurality of user attributes, that are stored in the reputation electronic database 228. The reputation engine 230 manages the processing of general incentives, and in particular, reputation points and badges (if implemented) corresponding to user actions. As an example, reputation engine 230 may use game of skills principles to reward certain types of user actions, such as submission of new evidence, or voting for or against an item of evidence associated with an edge in the network model.

Depending on the type of user action and the estimated amount of expertise and/or effort required to complete an action, a corresponding number of reputation points may be awarded to the user. A user can submit an original modification (i.e., the submitter) and other users can vote on the suggested modification (i.e., the voters). A user can vote to indicate approval or disapproval of an element of the network model, i.e., an edge, a node or a piece of supporting information or evidence. Once an edge or a portion of a network model has reached a minimum number of votes, the portion of the network may be ‘locked’ to further voting. For example, if a number of votes indicating approval for a particular edge defined by a BEL statement exceeds the verification threshold, then the corresponding edge may be locked, such that additional votes regarding the edge are not accepted. The organizer can decide, optionally with further scrutiny, that the edge that has been locked in the system has indeed been verified, and that this element of the network model reached consensus. In some implementations, an edge is locked unless new evidence is presented that refutes the consensus that was previously reached. If consensus is reached regarding a modification or a piece of evidence that was suggested by a submitter, additional points may be given to the submitter if the modification or the evidence is subsequently approved (the number of votes indicating approval exceeds the verification threshold). Alternatively, if the modification or evidence is rejected (the number of votes indicating approval is below the rejection threshold, or the number of votes indicating disapproval exceeds some other threshold), the originally awarded points that were assigned to the submitter may be partially or wholly deducted. In addition to assigning additional points or deducting points for a submitter, the voters may also receive additional points or may have points deducted based on whether the voters approve or disapprove the consensus. In some implementations, voters are awarded bonus points only if an element or a portion of the network model reaches consensus and their vote aligns with the consensus.

The reputation engine 230 may award other types of rewards based on other criteria. For example, reputation badges may be awarded as users complete a pre-defined set of actions. For example, a user may be awarded a badge if he/she creates (e.g., 3, 4, 5, 6, 7, 8, 9, 10 or any other suitable number) approved network edges. In some implementations, the badges do not affect a user's point total or leaderboard position, but are still an important acknowledgment of a user's contributions to the network model.

To mitigate attempts by certain users to obtain reputation points deceptively or by actions not based on evidence or expertise, the systems and methods of the present disclosure may use one or more quality review checks that are performed periodically or in real time by the organizer. The system may optionally provide tools and data to support the organizer in this effort. In one example, the co-occurrence of submission and voting activity between a group of users may be measured. A group of users that show an abnormal amount of activity supporting each other's submissions may have their activity reviewed by the organizer to confirm the scientific or technical rationale underpinning the actions. In addition, the system may only allow a limited number of user actions per unit time (e.g., per hour), in order to avoid the use of automated scripts to perform a high number of actions.

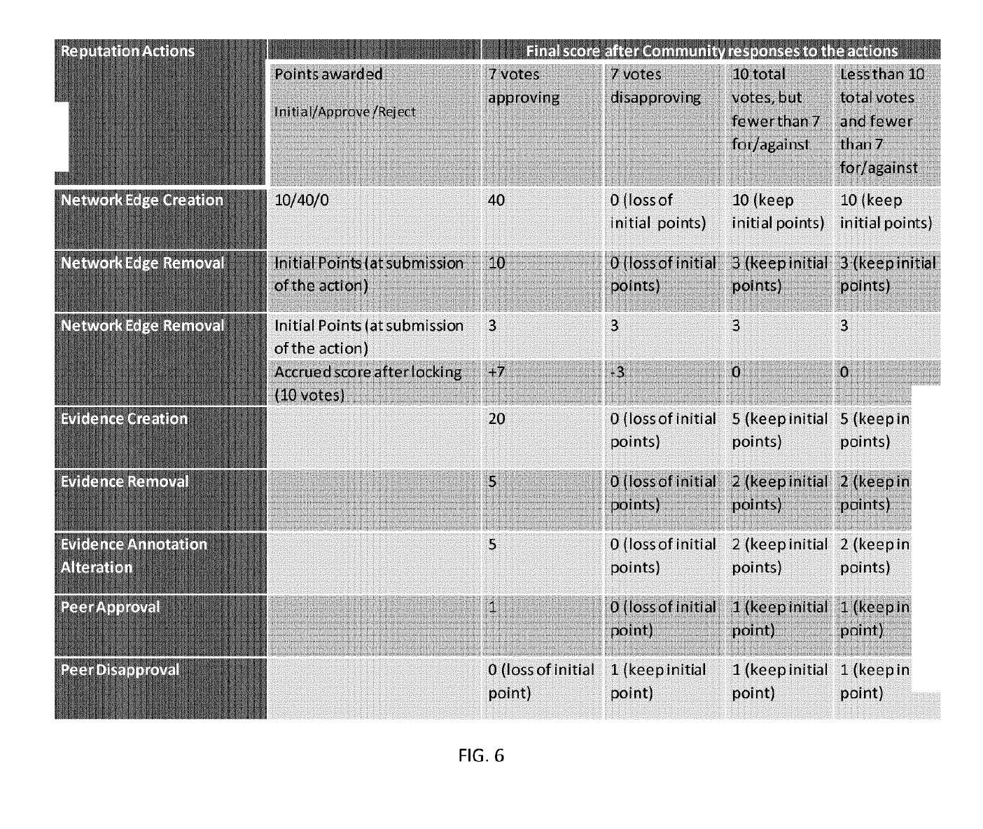

A leaderboard (see FIG. 6) may list a set of users or teams and their reputation points that is visible to the organizer, to some users, or to all users through the user interface. Accordingly, the leaderboard may be used to identify, from a community of users, high-scoring users who are likely to be highly-motivated individuals or experts in the subject matter area that is being model by the network.

According to the present disclosure, a biological system may be modeled as a mathematical graph consisting of nodes (or vertices) and edges that connect the nodes. The nodes may represent biological entities within a biological system, such as, but not limited to, compounds, DNA, RNA, proteins, peptides, antibodies, cells, tissues, and organs. The edges may represent relationships between the nodes. The edges in the graph may represent various relations between the nodes. For example, edges may represent a “binds to” relation, an “is expressed in” relation, an “are co-regulated based on expression profiling” relation, an “inhibits” relation, a “co-occur in a manuscript” relation, or “share structural element” relation. Generally, these types of relationships describe a relationship between a pair of nodes. The nodes in the graph may also represent relationships between nodes. Thus, it is possible to represent relationships between relationships, or relationships between a relationship and another type of biological entity represented in the graph. For example a relationship between two nodes that represent chemicals may represent a reaction. This reaction may be a node in a relationship between the reaction and a chemical that inhibits the reaction.

A graph may be undirected, meaning that there is no distinction between the two vertices associated with each edge. Alternatively, the edges of a graph may be directed from one vertex to another. For example, in a biological context, transcriptional regulatory networks and metabolic networks may be modeled as a directed graph. In a graph model of a transcriptional regulatory network, nodes would represent genes with edges denoting the transcriptional relationships between them. As another example, protein-protein interaction networks describe direct physical interactions between the proteins in an organism's proteome and there is often no direction associated with the interactions in such networks. Thus, these networks may be modeled as undirected graphs. Certain networks may have both directed and undirected edges. The entities and relationships (i.e., the nodes and edges) that make up a graph, may be stored as a web of interrelated nodes in a database.

The knowledge represented within the database may be of various different types, drawn from various different sources. For example, certain nodes may represent information on genes, and relations between them. In such an example, a node may represent an oncogene, while another node connected to the oncogene node may represent a gene that inhibits the activity or expression of the oncogene. The nodes may represent proteins, and relations between them, diseases and their interrelations, and various disease states. There are many different types of data that may be combined in a graphical representation. The computational models may represent a web of relations between nodes representing knowledge in, e.g., a DNA dataset, an RNA dataset, a protein dataset, an antibody dataset, a cell dataset, a tissue dataset, an organ dataset, a medical dataset, an epidemiology dataset, a chemistry dataset, a toxicology dataset, a patient dataset, and a population dataset.

Although proteins are encoded by genetic sequences, the changes in gene expression do not always correlate with changes in protein activity. The network models as described herein do not necessarily rely on these forward assumptions, but rather may infer the activity of an upstream node based on the expression of genes that the node regulates. “Forward reasoning” assumes that gene expression correlates with changes in protein activity, whereas “backward reasoning” or reverse causal reasoning considers the changes in gene expression as the consequence of the activity of an upstream entity. Thus, a network model may capture biology in the nodes and causal relationships between the nodes. In an example, differential expressions of genes are experimental evidence for the activation of an upstream node.

The network models used in the present disclosure that comprise nodes and edges indicating cause and effect based on reverse causal reasoning contains several advantages. First, nodes in the network are connected by causally related edges with fixed topology, allowing the biological intent of the network model to be easily understood by a scientist or a user, enabling inference and computation on the network as a whole. Second, unlike other approaches for building pathway or connectivity maps where connections are often represented out of a tissue or disease context, the network models herein are created according to appropriate tissue/cell context and biological processes. Third, the causal network models may capture changes in a wide range of biological molecules including proteins, DNA variants, coding and non-coding RNA, and other entities, such as phenotypic, chemicals, lipids, methylation states or other modifications (e.g., phosphorylation), as well as clinical and physiological observations. For example, a network model may be representative of knowledge from molecular, cellular, and organ levels up to an entire organism. Fourth, the network models are evolving and may be modified to represent specific species and/or tissue contexts by the application of appropriate boundaries and updated as additional knowledge becomes available. Fifth, the network models are transparent; the edges (cause and effect relationships) in the network model are all supported by published scientific findings anchoring each network to the scientific literature for the biological process being modeled. Finally, the network models may be provided in (.XGMML) format to allow easy visualization using freely available tools including Cytoscape [Smoot, M. E. et al. (2011) Cytoscape 2.8: new features for data integration and network visualization. Bioinformatics. 27, 431-432]. To fully capture the benefit of these network models, there is a need to generate, verify and disseminate network models rapidly which is met by the systems and methods disclosed herein.

In various implementations of the present disclosure, the network models of biological systems are encoded in a structured language that represents technical findings by capturing causal and correlative relationships between biological entities. The language enables the formation of computable statements that are composed by functions and entity definitions expressed with a defined ontology (e.g. HGNC, see www.genenames.org). BEL is an example of such a language used in an implementation of the present disclosure ([Talikka M, Schlage W K, Gebel S, et al. Toxicology Summit & Expo. Toxicology. 2012; Clark T, Ciccarese P N, Goble C A. Micropublications: a Semantic Model for Claims, Evidence, Arguments and Annotations in Biomedical Communications. arXiv preprint arXiv:1305.3506. 2013; Vercruysse S, Kuiper M. Jointly creating digital abstracts: dealing with synonymy and polysemy. BMC research notes. 2012; 5(1):601]) (www.openbel.org). A BEL statement is a semantic triple (subject, predicate, object) that represent discrete scientific causal relationships and their relevant contextual information. FIG. 4 shows an example of BEL statement. Functions and entity definitions expressed with a defined ontology (namespace). For example p(HGNC:CCND1)=>kin(p(HGNC:CDK4) is a statement equivalent to “Increased abundance of the protein designated by ‘CCND1’ in the HGNC namespace directly increases the kinase activity of the abundance of the protein designated by ‘CDK4’ in the HGNC namespace”. The rest of the BEL statement consists of fields pertaining to the context of the statement, such as the literature reference from which the statement was derived, the tissue, cell line, organism, and disease context of the statement.

One advantage of using BEL statements resides in the fact that it is both easily human-readable and machine-computable, making it an useful language to capture technical literature evidences from manual curation as well as data mining by machine. BEL may also display literature evidence in the context of visualizing a proposed network model. Additionally, tools are developed by the OpenBEL community and assembled in an emerging open-platform technology known as the BEL framework. One of ordinary skill in the art will understand that the present disclosure is not limited to BEL statements. Other languages may be used, such as systems biology markup language (SBML), without departing from the scope of the present disclosure.

The network model may be used as a substrate for simulation and analysis, and is representative of the biological mechanisms and pathways that enable a feature of interest in the biological system. The feature or some of its mechanisms and pathways may contribute to the pathology of diseases and adverse effects of the biological system. Prior knowledge of the biological system represented in a database is used to construct the network model which is populated by data on the status of numerous biological entities under various conditions including under normal conditions and under perturbation by an agent. The network model is dynamic in that it represents changes in status of various biological entities in response to a perturbation and may yield quantitative and objective assessments of the impact of an agent on the biological system.

The use of network models facilitates a variety of research applications, including drug discovery, personalized medicine, or toxicological risk assessment [Hoeng J, Deehan R, Pratt D, et al. A network-based approach to quantifying the impact of biologically active substances. Drug Discov Today. May 2012; 17(9-10):413-418]. Proof-of-principle verification for some of these applications has been previously published. In an example, dynamic changes were detected in the amplitude of perturbation in a network model describing the TNF-NFkB signaling following TNF treatment of normal human bronchial epithelial (NHBE) cells as described by gene expression data [Martin F, Thomson™, Sewer A, et al. Assessment of network perturbation amplitude by applying high-throughput data to causal biological networks. BMC Syst Biol. May 31, 2012; 6(1):54]. Importantly, the measured changes in network amplitude that were detected corresponded to direct experimental measurement of NFkB nuclear translocation following TNF treatment. This illustrates how network models may identify and quantitate chemically induced biological changes. This feature may be especially useful for the toxicology community as it seeks to replace expensive and lengthy in vivo toxicity testing with in vitro assays to measure chemical toxicity [Krewski D, Acosta D, Jr., Andersen M, et al. Toxicity testing in the 21st century: a vision and a strategy. J Toxicol Environ Health B Crit Rev. February 2010; 13(2-4):51-138].

Peer review of network models that capture known biology may improve the quality of the network and promote acceptance by a wider scientific community. The publication of articles describing the construction of the current network collections in peer reviewed journals is an initial step [Gebel S, Lichtner R B, Frushour B, et al. Construction of a computable network model for DNA damage, autophagy, cell death, and senescence. Bioinformatics and biology insights. 2013; 7:97-117; Westra J W, Schlage W K, Hengstermann A, et al. A Modular Cell-Type Focused Inflammatory Process Network Model for Non-diseased Pulmonary Tissue. Bioinformatics and Biology Insights. 7:1-26, 2013; Park J S, Schlage W K, Frushour B P, et al. Construction of a Computable Network Model of Tissue Repair and Angiogenesis in the Lung. Clinical Toxicology. 2013, S12; Schlage W K, Westra J W, Gebel S, et al. A computable cellular stress network model for non-diseased pulmonary and cardiovascular tissue. BMC Syst Biol. 2011, 5:168; Westra J W, Schlage W K, Frushour B P, et al. Construction of a computable cell proliferation network focused on non-diseased lung cells. BMC Syst Biol. 2011; 5:105]. However, there is a limit to what peer reviewers may verify, and the classical peer review system does not easily allow for a complete analysis of the datasets or the generated networks.

The systems and methods of the present disclosure enable a group of peer reviewers to efficiently and effectively provide feedback to a network model that is being updated in nearly real-time. For example, a researcher may have obtained a result regarding an edge of a network model. However, the researcher wishes to have experts in the field review his/her result before disseminating the result to the public. In this case, the researcher may take advantage of the systems and methods of the present disclosure by submitting the result as a suggested modification to the network model and waiting for feedback from other users in the form of votes or other evidentiary support. In this manner, the researcher may obtain feedback from other experts and peer reviewers (i.e., users in the system) regarding the result and may only select to disseminate the result to the public if the result is verified.

In another example, a researcher may have obtained a number of related results regarding multiple edges of a network model. Rather than immediately writing a manuscript including all of the results, the researcher may submit each of the results as individual modifications to the network model. In this case, the researcher receives feedback for each of the individual results, and may select to include or omit any of the initial results based on the received feedback in a subsequent publication.

In some implementations of the present disclosure, the network models possess a unique set of features that distinguishes the network models from, and makes them complementary to, the collection of signaling pathways and networks already available to the scientific community [Gebel S, Lichtner R B, Frushour B, et al. Construction of a computable network model for DNA damage, autophagy, cell death, and senescence. Bioinformatics and biology insights. 2013; 7:97-117; Schlage W K, Westra J W, Gebel S, et al. A computable cellular stress network model for non-diseased pulmonary and cardiovascular tissue. BMC Syst Biol. 2011; 5:168; Westra J W, Schlage W K, Frushour B P, et al. Construction of a computable cell proliferation network focused on non-diseased lung cells. BMC Syst Biol. 2011; 5:105]. Depositories such as STRING [Franceschini A, Szklarczyk D, Frankild S, et al. STRING v9.1: protein-protein interaction networks, with increased coverage and integration. Nucleic Acids Res. January 2013; 41(Database issue):D808-815] or HPRD [Keshava Prasad T S, Goel R, Kandasamy K, et al. Human Protein Reference Database—2009 update. Nucleic Acids Res. January 2009; 37(Database issue):D767-772] attempt to create a genome-wide picture of protein-protein interactions in an almost context-free setting, while other signaling pathway repositories (such as KEGG and BioCarta) may employ manual curation of the literature but do not offer significant biological context. The present disclosure provides curated network models constructed within precisely defined contextual boundaries for associated literature. In some implementations, other omics datasets, such as proteomics, metabolomics, or lipidomics, may be incorporated. The gene expression underlying these networks greatly facilitates the biological interpretation of complex datasets in the search for explanations of the observations. In some implementations, the network models are dynamic because they may be modified to represent specific species and/or tissue contexts by the application of appropriate boundaries and may be updated in real time as new knowledge becomes available.

Construction of a network model is a multi-step, iterative process, and is described in detail in previous publications [Schlage W K, Westra J W, Gebel S, et al. A computable cellular stress network model for non-diseased pulmonary and cardiovascular tissue. BMC Syst Biol. 2011; 5:168; Westra J W, Schlage W K, Frushour B P, et al. Construction of a computable cell proliferation network focused on non-diseased lung cells. BMC Syst Biol. 2011; 5:105]. Briefly, the construction of a network model starts with a careful selection of model boundaries, i.e. the selection of appropriate tissue/cell context and biological processes to be included in the model. Then, the relevant scientific literature is reviewed to extract causal relationships that comprise the literature model's nodes and edges. In one implementation of the present disclosure, the network model is based on gene expression data and constructed by applying reverse causal reasoning. Multiple data sets are used to test whether the network model represents the biological system being modeled, preferably from experiments where the experimental exposure perturbed the biological mechanisms captured by the network model under construction.

In some implementations of the present disclosure, model-building efforts may be assisted by text mining. Text mining generally involves the use of computer-implmented methods to analyse the text of the technical literature, retrieve selectively relevant terms and bring them into a structured relationship. The use of text mining may facilitate semi-automated assembly of BEL-encoded knowledge bases that may be used to construct a network model. The systems and methods as disclosed herein may offer a user an option to perform text mining based on information and knowledge concerning a set of nodes and edges, when the user is reviewing or modifying the nodes and edges in the set.

In some implementations, the network models are used for representing key biological processes implicated in human lung physiology and have been previously published: cell proliferation [Westra J W, Schlage W K, Frushour B P, et al. Construction of a computable cell proliferation network focused on non-diseased lung cells. BMC Syst Biol. 2011; 5:105], cellular stress [Schlage W K, Westra J W, Gebel S, et al. A computable cellular stress network model for non-diseased pulmonary and cardiovascular tissue. BMC Syst Biol. 2011; 5:168], cell fate [Gebel S, Lichtner R B, Frushour B, et al. Construction of a computable network model for DNA damage, autophagy, cell death, and senescence. Bioinformatics and biology insights. 2013; 7:97-117], pulmonary inflammation [Westra J W, Schlage W K, Hengstermann A, et al. A Modular Cell-Type Focused Inflammatory Process Network Model for Non-diseased Pulmonary Tissue. Bioinformatics and Biology Insights. 2013; 7:1-26], tissue repair and angiogenesis [Park J S, Schlage W K, Frushour B P, et al. Construction of a Computable Network Model of Tissue Repair and Angiogenesis in the Lung. Clinical Toxicology. 2013; S12]. In addition, four networks were built to model the pathophysiology of chronic obstructive pulmonary disorder (COPD). COPD is a common inflammatory lung disease in which the airways become narrowed, causing shortness of breath. COPD is a major and increasing global health problem. It is predicted by the World Health Organization to become the third most common cause of death and the fifth most common cause of disability in the world by 2020 [Lopez A D, Murray C C. The global burden of disease, 1990-2020. Nat Med. November 1998; 4(11):1241-1243]. The main risk factor for emphysema/COPD in the developed world is exposure to tobacco smoke [Pauwels R A, Buist A S, Calverley P M, Jenkins C R, Hurd S S. Global strategy for the diagnosis, management, and prevention of chronic obstructive pulmonary disease. NHLBI/WHO Global Initiative for Chronic Obstructive Lung Disease (GOLD) Workshop summary. Am J Respir Crit Care Med. April 2001; 163(5):1256-1276]. B-cell activation and T-cell recruitment and activation subnetworks were built to represent these immune processes and their role in COPD, and extracellular matrix (ECM) degradation and efferocytosis subnetworks were constructed by modifying models based on healthy physiology to model COPD-relevant mechanisms. For example, the set of networks that describe the biological systems implicated in COPD in humans may be made available over the network 102 for curation by multiple users.

While most of the disclosure relates to biological network models, one of ordinary skill in the art will understand that the systems and methods of the present disclosure may be applied to any type of network, such as an ecological networks or any other type of system that may include nodes and edges representative of causal relationships between nodes.

The systems and methods of the present disclosure comprise an integrated social reputation system that encourages high-quality evidence-based contributions and the development of a consensus network model. The systems and methods of the present disclosure incorporate both traditional and non-traditional incentives to promote user activity. Among the non-traditional incentives is the application of gamification principles. Such principles apply game mechanics to specific problems and tasks to engage user interest and activity and positively motivate participants with non-traditional incentives. As described herein, the systems and methods of the present disclosure take advantage of the recognition that a general desire to improve one's reputation will lead to a better curated network model. This interplay between the integrated reputation system and the verification process improves upon other reputation systems that provide only a ranking of users but do not lead to or relate to the progress made towards a goal set by the organizer. In particular, the quality of the resulting curated model is improved when users contribute knowledge and opinions to the system, and the reputation system encourages performance of these user actions.

For example, the reputation gained by participating in a game of skills becomes part of the reward for performing a task, as opposed (or in addition) to material incentives such as financial awards, i.e. traditional incentives. Reputation may be measured by points accrued from the performance of different actions or by badges awarded for the fulfillment of specific criteria. Users may accrue reputation points, reputation badges, or a combination of both, as well as interact with the larger network of users through a leaderboard system and infrastructure that supports annotations and comments. The award of reputation points to users may be based exclusively on or biased towards contributions of knowledge, evidence, or both in contrast to award that are exclusively or mostly based on computational actions, such as calculations that consume high computational resource. Unlike a gaming scenario where a reputation system may simply recognize a winner, the network model curation scenario of the present disclosure combined with an integrated reputation system leads to a greater understanding and sharing of knowledge. By placing an emphasis on the scientific information provided, the present disclosure confines gamification components to the leaderboard to drive friendly competition and engagement.

In particular, integrating a reputation point system with a network curation system results in a more robust verification process that provides a better network model than a network curation system without a reputation point system. In particular, the integrated reputation system motivates the users to contribute to the network model by performing user actions such as voting, suggesting modifications, or providing evidence in support of a part of the network model or to refute previously provided evidence. The motivation to contribute to the network model stems from a desire for gaining a reputation within the user community. Beyond the gamification aspect, with reputation points, reputation badges, and leaderboard system, any number of number of professional and scientific incentives may be offered to stimulate participation and engagement. For example, in some implementations, users are granted access to the curated network model before the model is being disseminated to non-users. In an alternative implementation, users that achieve a certain number of points may be able to download selected portions of the network model, such as those nodes and edges that are connected to nodes and edges acted upon by the user with various degrees of connectedness. Several implementations of reputation systems are described below, but one of ordinary skill in the art will understand that a reputation system may include any motivational tool to encourage users to contribute to the development of a network model, without departing from the scope of the present disclosure.

The organizer of a project may set up the integrated reputation system to award reputation points. In general, the reputation system awards a number of reputation points for each type of user action. The number of points awarded may be predefined and corresponds to a type of user action under certain specific conditions. Votes can be casted by users to indicate approval or disapproval of a piece of evidence associated with a node or an edge in a network model.

For example, a user who votes to approve a piece of evidence that supports an existing edge in a network model, thereby verifying the relationship represented by the edge, may be awarded a certain number of reputation points. In another example, the user may vote to disapprove a piece of evidence that supports the edge, thereby not verifying or refuting the relationship represented by the edge. In this case, the user may be awarded the same or a different number of reputation points. If the user provides a suggested modification to the edge, such as changing one or both nodes, or changing a value associated with the edge between the two nodes, the user may be awarded a similar or different number of reputation points.

In certain implementation, the number of reputation points rewarded to a user for a user action may depend on the status of the network model and also depend in part on certain conditions which vary with time. For example, a user who performs an action related to an edge that is already associated with many votes may be awarded fewer reputation points than if the user performed an action related to an edge that is associated with fewer votes. In this case, as incoming votes are accumulated for an edge, the relative usefulness of each vote and the number of points awarded may decrease with each incoming vote. This dynamic change in the number of points awarded associated with user action on this edge may be communicated to the user community to encourage users to take action in other portions of the network that are receiving less attention. In this manner, the number of reputation points awarded to a user for an action directed to an edge may be dependent on how much user activity (i.e., the number of prior user actions that) has been received for the edge or that portion of the network model in which the edge is located. This aspect of the integrated reputation system can be moderated by the organizer manually, by the reputation system programmed according to a set of conditions (FIG. 6), or a combination of both manual or automated actions.

In some implementations, the number of reputation points awarded to a user may be dependent on the nature of previous actions, subsequent actions, or both types of actions regarding an element or a portion of the network in which the element is located. In an example, the number of reputation points awarded to a user who provides a user action associated with a node or an edge may be based on a history of user actions associated with the node or edge. For example, if an edge is associated with a similar number of votes indicating approval as indicating disapproval, the edge may be marked as not yet verified, and a user who provides evidence associated with the edge may be rewarded an additional number of reputation points if the evidence is later approved by other users leading to verification of the edge. In another example, the total number of reputation points awarded to a user who provided a user action associated with a node or an edge may be based on subsequent user actions associated with the node or edge. An example of subsequent user actions that can lead to an additional award of reputation points is the verification of an edge or a node when the number of votes indicating approval or disapproval reaches or exceeds a threshold, i.e., a verification threshold or a rejection threshold. Thus, if the user is the initial provider of a vote indicating approval, and when a sufficient number of votes are received that cause the node or edge to be verified, the initial voter may be awarded additional reputation points. In this example, the points awarded by the reputation system is integrated with the progress made in verification and curation of the network model.

In some implementations, the number of reputation points awarded to users may be predetermined by the substance that is represented an edge or a portion of a network model. In particular, certain nodes or edges of a network model may represent subject matter that is notoriously difficult, that are controversial and thus require resolution, or that are important to the organizer. For example, nodes that are connected to many other nodes may be associated with a larger number of reputation points than other nodes that are connected to fewer nodes. Similarly, the edges associated with such highly connected nodes may be associated with a larger number of reputation points than other edges associated with less connected nodes. In general, the points awarded by the reputation system reflect the progress made in verification and curation of the network model.

In some implementations, portions of the network model (such as a set of BEL statements or pieces of evidence concerning one or more BEL statements) are verified when the score or the number of votes indicating approval exceeds a verification threshold, or equivalently, when a number of users that approve a part of the model exceeds the verification threshold. As used herein, the term “score” includes a number of votes indicating approval of a corresponding portion of a network model, a number of votes indicating disapproval, or an expression derived from the number of votes indicating approval and the number of votes indicating disapproval. For example, a score of an element (such as an edge, a node, or a piece of evidence supporting an edge or a node, for example) of the network model may correspond to an absolute number of votes indicating approval of the element. The verification threshold may be exceeded when an absolute number of votes indicating approval exceeds a predetermined value. In another example, the score of the element of the network model may correspond to a ratio between the number of votes indicating approval and the number of votes indicating disapproval of the element. In this case, the verification threshold may be reached when the number of votes indicating approval exceeds twice (or any other suitable factor) the number of votes indicating disapproval.

The rejection threshold may be defined similarly or differently from the definition of the verification threshold. In another example, the score of the element of the network model may correspond to an absolute number of votes indicating disapproval of the element. A rejection threshold may be defined in terms of the number of votes indicating disapproval, the number of votes indicating approval, or a combination thereof. In an example, the score may correspond to an absolute number of votes indicating disapproval. In this case, the rejection threshold may be reached when a minimum absolute number of votes indicating disapproval have been received. In another example, the score may correspond to an absolute number of votes indicating approval. In this case, the rejection threshold may be reached when a minimum absolute number of votes indicating approval have not been received. In yet another example, the score may correspond to a ratio between the number of votes indicating disapproval and the number of votes indicating approval. In this case, the rejection threshold may be reached when the score or the ratio fails to exceed some predetermined value. For example, the rejection threshold may be reached when the number of votes indicating disapproval exceeds twice (or any other suitable factor) the number of votes indicating approval. In any of these cases, when the rejection threshold is reached, the corresponding element or portion of the network model may be identified as rejected, and one or more of these portions may be marked as not verified or deleted from the network model.

In some implementations, still other portions of the network model are identified as controversial, and one or more of these portions may be marked for further investigation. In particular, the controversial portions of the network may correspond to those for which no consensus was reached at a certain time after the project started. In other words, neither the verification threshold nor the rejection threshold was reached. This may happen if too few total votes were received, or if a similar number of votes indicating approval on the one hand and votes indicating disapproval was received. The systems and methods of the present disclosure can therefore be used to identify edges, nodes, or portions of a network model that is not verified or not verifiable, and thus not suitable for dissemination. Such edges, nodes, or portions of network model may be communicated to the users, the organizer or both for further investigation and curation.

In some implementations, as was described above, once an edge or a portion of a network model or evidence associated therewith has reached a predefined minimum number of votes, the edge or portion of the network model or the evidence in association therewith may be ‘locked’ and prevented from further voting. For example, additional votes regarding the evidence, edge or portion of the network model may not be entered into the system if consensus has already been reached. When a consensus is reached, an additional number of reputation points may be assigned to one or more users who previously voted on the evidence, edge, or portion of the network model. For example, users who voted to approve a piece of evidence supporting an edge that was ultimately verified in the network model may be awarded bonus reputation points for voting correctly. In addition, the original submitter of the modification or supporting evidence that was ultimately verified, and the earlier voters may be awarded additional bonus reputation points compared to the later voters.

In some implementations, other types of rewards are assigned based on other criteria. For example, reputation badges may be awarded as users complete a pre-defined set of actions. For example, a user may be awarded a badge if the user creates or modifies network edges that are subsequently verified after a period of time.

Within the scope of crowd curation of biological networks and the online verification of that curation, a submission, approval, and commenting system is designed to encourage scientists to critically evaluate evidence supporting various network relationships. When verifying edges and nodes, users may be required to use a controlled syntax (such as in the form of a BEL Statement, for example) and may generally support their actions with a reference to one or more peer-reviewed publications. The use of the BEL Statement with references ensures structural and logical correctness and addresses an important concern regarding knowledge curation platforms: consistency checking [Groza T, Tudorache T, Dumontier M. State of the art and open challenges in community-driven knowledge curation. Journal of biomedical informatics. February 2013; 46(1):1-4]. BEL Statements enforce consistent input structures that enable evidence evaluation algorithmically or manually. The requirement of references allows other participants to judge the applicability and logical soundness of the comment or modification to the network, species, tissue, or process being verified.

By implementing a system that rewards network verification and modifications that are approved by a wider set of users, the systems and methods of the present disclosure places greater emphasis and importance on high-quality curating actions. Indiscriminate user actions are unlikely to be awarded bonus reputation points. In certain implementation, a slightly greater burden may be placed on votes indicating disapprovalby requiring voters to offer additional or new evidence to support this type of user action. Malicious or arbitrary down-voting is discouraged. Yet, if this disapproval action is appropriate and the edge or evidence associated with the edge is subsequently disapproved, the voter may be awarded a bonus point to reward the identification of incorrect actions.

In some implementations, prior to the locking of an edge, evidence associated with an edge or a portion of a network model, any user may view the votes or comments on that edge or that piece of evidence or that portion of the network model, but the usernames of the users who contributed to the votes, comments, additional evidence or modification of the model may not be viewable by the other users. The user actions may be kept anonymous to prevent undue influence on subsequent user actions. However, in certain implementations, when an edge or a piece of evidence or a portion of a network model is locked, the usernames of submitters and voters may be viewable by all the users. Such transparency may be useful in generating a persistent dialog among users that may be carried over to others portions of the network.

In some implementations, a leaderboard system is used to offer users an understanding of their relative performance in the overall network curation project and optionally, within each specific subnetwork or portion of the network. The leaderboard system may be designed to encourage friendly competition and greater engagement within each of the subnetworks. In some implementations, leaderboards may indicate username, rank as determined by total number of reputation points, and specific metrics such as quantity of edges created, approved and disapproved. In some implementations, the leaderboards may operate at a global level, including reputation points gained by the actions taken by a user in other past or current network curation projects. In certain implementations, to promote competition and continued engagement while avoiding discouragement due to large differences in point totals, users may only be able to see the ranks and points of the 5 users above and below their rank within each of the global or specific network leaderboards. The top 5 (or any other suitable number) usernames for all leaderboards may be shown, though without their point totals, to reward top contributors without discouraging other participants.

In some implementations, the systems and methods described herein request for input from users in the form of user actions. The request may be a passive and general request for user actions related to a network model. In this case, a representation of the network model (which may be an initial network model or a modified version of the initial network model) is displayed over one or more user interfaces, and the users may select various elements or portions of the network model to provide input. In another example, the request may be an active or specific request for user actions related to a particular element or portion of the network model. In this case, the representation of the network model may be displayed over one or more user interfaces, and the specified element or portion of the network model may be highlighted, magnified, or specially displayed in some way. After transmitting the requests for user actions over the computer network, the systems and methods described herein receive user actions from multiple users, and may assign reputation points to each user based on the type of user action received and any other factor related to the user action or the corresponding element of the network model. The number of reputation points accumulated by each user may be used to assign rankings to the users, and the rankings may be used to form a leaderboard (such as a list of the users with the highest number of reputation points, sorted according to the number of reputation points). The leaderboard or a portion thereof may be displayed to the users during the network verification phase, after the network verification phase, or both. The leaderboard may be updated in real time as reputation points are rewarded to users, or the leaderboard may be updated periodically, such as every fixed time interval, such as every hour, every day, or any other sutiable time interval.

In some implementations, the network verification phase is completed when a threshold number of user actions is received (such as when 50, 100, 200, or any other suitable number of user actions are received for the network model, or when 5, 10, 20, or any other suitable number of user actions are received for one or more portions of the network model, for example), when a threshold number of verified modifications to the initial network model are performed, when a threshold amount of time has passed (such as 10, 20, 50, 100, or any other suitable number of days, weeks, or months, for example), or any suitable combination thereof. As described herein, when the leaderboard is displayed during the network verification phase, the leaderboard may include a count down to or an indication of the end of the network verification phase. For example, the displayed leaderboard may include a number of days or hours left remaining in the network verification phase. In another example, the displayed leaderboard may include a number of user actions received since the start of the verification phase or a number of user actions needed to be received before the conclusion of the verification phase.

In some implementations, users may participate as individuals or as a team. Though users may ultimately be evaluated as individuals, the self-identification with others as a team may encourage participation within and competition between groups. In addition, the infrastructure of the present disclosure may be maintained and available to the community for further action even after the official close of a project. Furthermore, a user's visibility may be increased if the user rises to the top of a network's leaderboard. Rising to the top of a leaderboard may help a user to gain prominence as an expert in the subject matter area.

As an example, FIG. 6 is a table that depicts a system that lists a number of reputation points that may be awarded for various types of user actions. As shown in FIG. 6, the verification threshold as well as the rejection threshold are both set at 7 votes. In addition, participants' motivation may be further increased when their reputation is made visible on a leaderboard to others during the game, instead of solely provided at the conclusion. To complement the individual leaderboards, team or institution leaderboards may be used to encourage collaborative competition.

In some implementations, scientists are incentivized to actively contribute to networks of interest and develop new understanding through discourse with other domain experts. This communication may be facilitated via a commenting system available throughout the network, which allows users to provide remarks and responses specific to individual nodes and edges. The social aspect of the present disclosure may be an important feature as it encourages users to engage with academic peers to drive the approval and disapproval of network actions. It offers the opportunity not only to gain reputation but also to commit changes to the network that represent validated information from which new insights may be made. This push towards greater interaction naturally increases a user's personal network, which is traditionally an important component of a scientific career.

In some implementations, the results of the network model verification process are evaluated to identify different portions of the network model that are verified, rejected, or indicated as controversial. By identifying these various portions of the network model, the organizer may determine to what extent knowledge about the subject matter area wasfurther expanded, revised or invalidated during the network curation project. To aid the organizer in interpreting the results of the network curation project, one or more of the following exemplary metrics may be analyzed: the amount of evidence supporting each edge, before and after the project; the specificity of contextual annotations for each node or edge relative to the network's intended context, before and after the process; the ratio of positive and negative comments or votes for each node or edge prior to locking; the number of editing actions for each edge; the number of edge deletion actions; and the number of locked versus unlocked edges.

In some implementations, the transactions and the resulting network are examined to determine whether the gamification principles produced unwanted artifacts, such as unproductive activities performed by users simply to gain points. If there are any unusual patterns of success by individuals or groups, the technical conclusion of the resulting statements and edges may be reviewed to determine whether the technical content of the final network was in any way compromised for the sake of competition. In some implementations, the results of the network model curation projectare evaluated to identify the experts in the field as the highest scorers according to the reputation system.

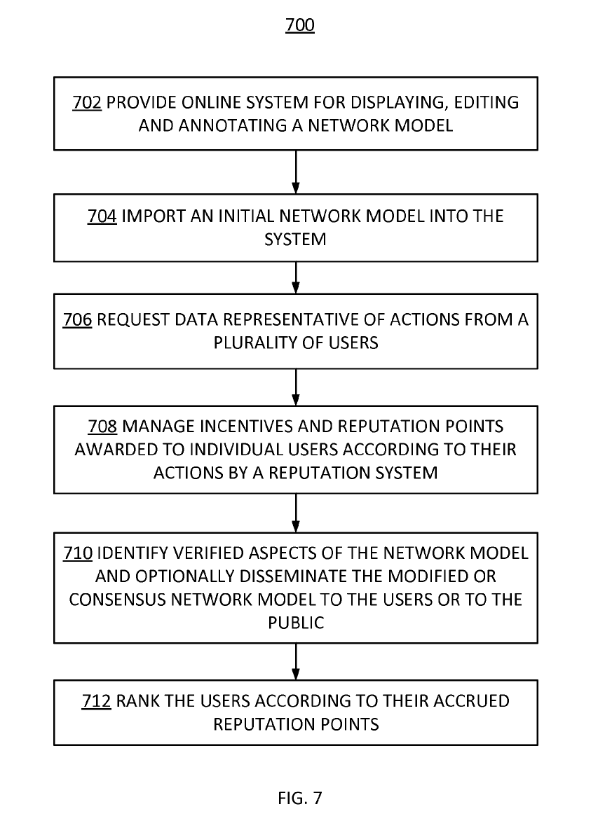

FIG. 7 is a flow chart of a method 700 for curating a network model. The method 700 includes the steps of providing an online system for displaying, editing, and annotating a network model (step 702), importing an initial network model into the system (step 704), requesting data representative of actions from a plurality of users (step 706), managing incentives and reputation points awarded to individual users according to their actions by a reputation system (step 708), identifying verified aspects of a network model and optionally disseminating the modified/consensus network model to the users or the public (step 710), and ranking users according to their accrued reputation points (step 712).

The systems and methods of the present disclosure provide a curated network model. A network model including nodes and edges is provided, and user actions directed to at least one node or at least one edge are received. Based on the number of user actions received for each respective edge, a weight is assigned to the respective edge. A confirmed subset of edges and a rejected subset of edges are identified. The edges in the confirmed subset have assigned weights that exceed a confirmation threshold, and the edges in the rejected subset have assigned weights that are below a rejection threshold. Then, the confirmed subset of edges and the associated nodes are provided as a curated network model, where the curated network model omits the rejected subset of edges.

FIG. 3 is a block diagram of a computing device, such as any of the components of system 100 of FIG. 1 for performing processes described herein. Each of the components of system 100, including the network model database 106 or 206, user devices 108, server 104 or 204, processor 105 or 205, website manager 222, reputation electronic database 228, reputation engine 230, network visualization engine 224, or web-based statement editor 226 may be implemented on one or more computing devices 300. In certain aspects, a plurality of the above-components and databases may be included within one computing device 300. In certain implementations, a component and a database may be implemented across several computing devices 300.

The computing device 300 comprises at least one communications interface unit, an input/output controller 310, system memory, and one or more data storage devices. The system memory includes at least one random access memory (RAM 302) and at least one read-only memory (ROM 304). All of these elements are in communication with a central processing unit (CPU 306) to facilitate the operation of the computing device 300. The computing device 300 may be configured in many different ways. For example, the computing device 300 may be a conventional standalone computer or alternatively, the functions of computing device 300 may be distributed across multiple computer systems and architectures. The computing device 300 may be configured to perform some or all of modeling, scoring and aggregating operations. In FIG. 3, the computing device 300 is linked, via network or local network, to other servers or systems.

The computing device 300 may be configured in a distributed architecture, wherein databases and processors are housed in separate units or locations. Some such units perform primary processing functions and contain at a minimum a general controller or a processor and a system memory. In such an aspect, each of these units is attached via the communications interface unit 308 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 306 comprises a processor, such as one or more conventional microprocessors and one or more supplementary co-processors such as math co-processors for offloading workload from the CPU 306. The CPU 306 is in communication with the communications interface unit 308 and the input/output controller 310, through which the CPU 306 communicates with other devices such as other servers, user terminals, or devices. The communications interface unit 308 and the input/output controller 310 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 306 is also in communication with the data storage device. The data storage device may comprise an appropriate combination of magnetic, optical or semiconductor memory, and may include, for example, RAM 302, ROM 304, flash drive, an optical disc such as a compact disc or a hard disk or drive. The CPU 306 and the data storage device each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 306 may be connected to the data storage device via the communications interface unit 308. The CPU 306 may be configured to perform one or more particular processing functions.

The data storage device may store, for example, (i) an operating system 312 for the computing device 300; (ii) one or more applications 314 (e.g., computer program code or a computer program product) adapted to direct the CPU 306 in accordance with the systems and methods described here, and particularly in accordance with the processes described in detail with regard to the CPU 306; or (iii) database(s) 316 adapted to store information that may be utilized to store information required by the program. In some aspects, the database(s) includes a database storing experimental data, and published literature models.

The operating system 312 and applications 314 may be stored, for example, in a compressed, an uncompiled and an encrypted format, and may include computer program code. The instructions of the program may be read into a main memory of the processor from a computer-readable medium other than the data storage device, such as from the ROM 304 or from the RAM 302. While execution of sequences of instructions in the program causes the CPU 306 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to modeling, scoring and aggregating as described herein. The program also may include program elements such as an operating system 312, a database management system and “device drivers” that allow the processor to interface with computer peripheral devices (e.g., a video display, a keyboard, a computer mouse, etc.) via the input/output controller 310.

The term “computer-readable medium” as used herein refers to any non-transitory medium that provides or participates in providing instructions to the processor of the computing device 300 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer may read.

Various forms of computer readable media may be involved in carrying one or more sequences of one or more instructions to the CPU 306 (or any other processor of a device described herein) for execution. For example, the instructions may initially be borne on a magnetic disk of a remote computer (not shown). The remote computer may load the instructions into its dynamic memory and send the instructions over an Ethernet connection, cable line, or even telephone line using a modem. A communications device local to a computing device 300 (e.g., a server) may receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Each reference that is referred to herein is hereby incorporated by reference in its respective entirety.

While implementations of the disclosure have been particularly shown and described with reference to specific examples, it should be understood by those skilled in the art that various changes in form and detail may be made therein without departing from the scope of the disclosure as defined by the appended claims. The scope of the disclosure is thus indicated by the appended claims and all changes which come within the meaning and range of equivalency of the claims are therefore intended to be embraced.

1. A computerized method for curating a network model, the method comprising:
providing, by a computer system including a communications port and at least one computer processor in communication with at least one non-transitory computer readable medium storing at least one electronic database comprising data representative of an initial network model and elements of the initial network model, the initial network model including a plurality of nodes interconnected with a plurality of edges, each edge being representative of a causal relationship between two connected nodes;
requesting user actions from a plurality of users, the user actions being directed to an element of the network model, wherein the element comprises an edge, a node or an item of information associated with an edge or a node;
assigning an approval score and a rejection score to each element of the network model based on the user actions received for the respective element;
identifying a first set of elements that each have an approval score that exceeds a verification threshold;
identifying a second set of elements that each have a rejection score that exceeds a rejection threshold;
identifying a third set of elements that each have an approval score that is below the verification threshold and a rejection score that is below the rejection threshold;
generating a curated network model that comprises the first set of elements, omits the second set of elements, and omits the third set of elements; and
providing via the communications port data representative of the curated network model.

2. (canceled)

3. (canceled)

4. The computerized method of claim 1, wherein at least one user action includes a suggestion for a new element previously absent from the network model, the method further comprising:
requesting user actions directed to the new element, and
modifying the initial network model or the curated network model by including the new element after the new element is verified by determining that an approval score of the new element exceeds the verification threshold.

5. (canceled)

6. The computerized method of claim 1, wherein at least some of the user actions are binary votes provided by the users that indicate whether the user approves or disapproves an element of the network model.

7. The computerized method of claim 1, wherein the score assigned to a respective element is a function of the number of received user actions directed to the respective element, a characteristic of each of the received user actions, or both, and wherein the characteristic of each of the received user action includes an indication of whether the respective user action is of a positive nature or of a negative nature.

8. (canceled)

9. (canceled)

10. (canceled)

11. The computerized method of claim 1, wherein the network model represents a biological system, each node represents a biological entity that interacts with at least one of the other nodes, and each edge represents a causal relationship between the biological entities.

12. The computerized method of claim 11, wherein the data that represents the network model is provided using Biological Expression Language.

13. The computerized method of claim 1, further comprising managing incentives awarded to individual users according to the user actions of each respective user by an integrated reputation system.

14. The computerized method of claim 13, wherein the integrated reputation system awards a number of points to a user according to the user action, wherein the number of points awarded is modified according to the status of the network model, said status being determined by one or more factors comprising the number of user actions received for the element, the nature of the user actions received for the element, or the location of the node or edge relative to the other nodes and edges in the network model.

15. The computerized method of claim 14, wherein the integrated reputation system awards additional points to a user based on a user action directed to the verification of an element, prior to the element being verified by subsequent user actions, and wherein a number of points assigned to a user who provided the new element is larger than a number of points assigned to a user who provided a modification of an existing element in the network model.

16. (canceled)

17. The computerized method of claim 1, wherein the network model is a biological network model that represents a biological system, the biological network model being a subset of a macro network model and being defined by selecting a boundary of the macro network model.

18. (canceled)

19. (canceled)

20. (canceled)

21. (canceled)

22. (canceled)

23. The computerized method of claim 1, further comprising requesting additional user actions from the plurality of users, the additional user actions being directed to specifically the third set of elements.

24. The computerized method of claim 14, wherein the number of points awarded to the user for a voting user action is less than the number of points awarded to the user for a user action that provides a new element.

25. The computerized method of claim 14, wherein:
a first element is associated with at least a threshold number of user actions;
a second element is associated with less than the threshold number of user actions; and
the number of points awarded to the user for a user action associated with the first element is less than the number of points awarded to the user for a user action associated with the second element.

26. The computerized method of claim 14, wherein the number of points awarded to the user for a user action associated with an element in the third set of elements is larger than the number of points awarded to the user for a user action associated with an element in the first set of elements or in the second set of elements.

27. The computerized method of claim 1, further comprising determining that user actions received from a subset of users within the plurality of users are correlated, and rejecting the user actions received from the subset of users.

28. A system for curating a network model, the system comprising:
at least one electronic database comprising data representative of an initial network model and elements of the initial network model, the initial network model including a plurality of nodes interconnected with a plurality of edges, each edge being representative of a causal relationship between two connected nodes;
a communications port configured to (1) transmit requests for user actions from a plurality of users, the user actions being directed to an element of the network model, wherein the element comprises an edge, a node or an item of information associated with an edge or a node, and (2) provide data representative of a curated network model;
at least one computer processor configured to:
request user actions from a plurality of users, the user actions being directed to an element of the network model, wherein the element comprises an edge, a node or an item of information associated with an edge or a node;
assign an approval score and a rejection score to each element of the network model based on the user actions received for the respective element;
identify a first set of elements that each have an approval score that exceeds a verification threshold;
identify a second set of elements that each have a rejection score that exceeds a rejection threshold;
identify a third set of elements that each have an approval score that is below the verification threshold and a rejection score that is below the rejection threshold; and
generate the curated network model that comprises the first set of elements, omits the second set of elements, and omits the third set of elements.

29. The system of claim 28, wherein at least one user action includes a suggestion for a new element previously absent from the network model, and the at least one computer processor is further configured to:
request user actions directed to the new element, and
modify the initial network model or the curated network model by including the new element after the new element is verified by determining that an approval score of the new element exceeds the verification threshold.

30. The system of claim 28, wherein:
the at least one computer processor is further configured to manage incentives awarded to individual users according to the user actions of each respective user by an integrated reputation system;
the integrated reputation system awards a number of points to a user according to the user action;
the number of points awarded is modified according to the status of the network model, said status being determined by one or more factors comprising the number of user actions received for the element, the nature of the user actions received for the element, or the location of the node or edge relative to the other nodes and edges in the network model;
the integrated reputation system awards additional points to a user based on a user action directed to the verification of an element, prior to the element being verified by subsequent user actions; and
a number of points assigned to a user who provided the new element is larger than a number of points assigned to a user who provided a modification of an existing element in the network model.

31. The system of claim 30, wherein:
the number of points awarded to the user for a voting user action is less than the number of points awarded to the user for a user action that provides a new element;
a first element is associated with at least a threshold number of user actions;
a second element is associated with less than the threshold number of user actions; and
the number of points awarded to the user for a user action associated with the first element is less than the number of points awarded to the user for a user action associated with the second element; and
the number of points awarded to the user for a user action associated with an element in the third set of elements is larger than the number of points awarded to the user for a user action associated with an element in the first set of elements or in the second set of elements.

31. The system of claim 28, wherein the at least one computer processor is further configured to request additional user actions from the plurality of users, the additional user actions being directed to specifically the third set of elements.

32. The system of claim 28, wherein the at least one computer processor is further configured to determine that user actions received from a subset of users within the plurality of users are correlated, and rejecting the user actions received from the subset of users.
